(19) United States
(12) Patent Application Publication
(10) Pub. No.: US 2004/0038120 A1
(43) Pub. Date: Feb. 26, 2004

(54) Metal air cell incorporating easily refuelable electrodes

(76) Inventors: Tsepin Tsai, Chappaqua, NY (US); Aditi Vartak, Lake Mohegan, NY (US)

Correspondence Address: Reveo, Inc., 85 Executive Blvd., Elmsford, NY, 10523, US

(21) Appl. No.: 10/452,834

(22) Filed: Jun. 2, 2003

Related U.S. Application Data
(60) Provisional application No. 60/384,547, filed on May 31, 2002.

(51) Int. Cl. H01M 12/06

(52) U.S. Cl. 429/66; 429/27

(57) ABSTRACT

An anode structure is provided that compensates for anode expansion during cell discharge, maintains substantially uniform distance between the anode and cathode, and/or facilitates anode removal for refueling operations. The anode structure generally includes metal fuel, a current collector in electric contact with the metal fuel, and a compressible member in mechanical cooperation with the metal fuel and/or current collector.

### RELATED APPLICATIONS

The present invention claims priority to U.S. Provisional Application Serial No. 60/384,547 filed May 31, 2002, the disclosure of which is hereby incorporated by reference.

### BACKGROUND OF THE INVENTION

1. Field of the Invention

This invention relates to refuelable metal-air electrochemical cells, particularly those incorporating self-adjusting anode configurations.

2. Description Of The Prior Art

Electrochemical power sources are devices through which electric energy can be produced by means of electrochemical reactions. These devices include metal air electrochemical cells such as zinc air and aluminum air batteries. Certain metal electrochemical cells employ an anode comprised of metal particles that are fed into the cell and consumed during discharge. Metal air cells include an anode, an air cathode, and an electrolyte. The anode is generally formed of metal particles immersed in electrolyte. The cathode generally comprises a semi permeable membrane and a catalyzed layer for reducing the oxidant, generally oxygen. The electrolyte is usually an ionic conductive but not electrically conductive material.

Certain metal-air cells are primary type of electrochemical cells, however can be reused by refueling. This method involves replacing used up metal fuel by fresh (or externally recharged, e.g., via an external charger) metal. This method has following advantages

Refueling is quick. It does not require extended amount of time like in recharging.

Used metal fuel can be converted back to its useful form more economically and efficiently in large quantities.

FIG. 1(a) shows typical refuelable electrochemical cell, which includes anode-cap assembly 102, an electrolyte 104 and a cathode 106. FIG. 1(b) shows the same cell during discharging or at the end of discharging. As seen from FIG. 1(b), during discharging the anode material expands and has following negative effects:

Pressure is exerted on the cathode, which causes cathode bulging.

Cathode bulging results in a reduced air gap between electrochemical cells thus reducing power and efficiency of the battery.

Refueling becomes difficult because of the expanded anode.

Due to the pressure developed inside the cell, electrolyte may be accidentally discharged from the cell through the cathode or through anode cap sealing, causing imbalance in electrolyte level.

Electrolyte leaked from the cell corrodes metal parts and other unprotected assembly components thus reducing cell performance.

Therefore, a need remains in the art for a metal air cell that minimizes or preferably eliminates the problems associated with cell expansion during discharge.

### SUMMARY OF THE INVENTION

The above-discussed and other problems and deficiencies of the prior art are overcome or alleviated by the electrochemical cell systems of the present invention, wherein an anode structure is provided that compensates for anode expansion during cell discharge, maintains substantially uniform distance between the anode and cathode, and/or facilitates anode removal for refueling operations. The anode structure generally includes metal fuel, a current collector in electric contact with the metal fuel, and a compressible member in mechanical cooperation with the metal fuel and/or current collector.

The above-discussed and other features and advantages of the present invention will be appreciated and understood by those skilled in the art from the following detailed description and drawings.

### BRIEF DESCRIPTION OF THE DRAWINGS

FIG. 1A is a schematic representation of an electrochemical cell;

FIG. 1B is a schematic representation of an electrochemical cell after discharge;

FIG. 2 shows a cell according to the present invention;

FIGS. 3A-3D depict a generalized embodiment of a cell system including a compressible and expandable anode structure for reducing resistivity, compensating for anode expansion, and facilitating anode removel;

FIGS. 4A-4B depict one embodiment of a compressible and expandable anode structure;

FIGS. 5A-5B depict another embodiment of a compressible and expandable anode structure

FIGS. 6A-6C depict a further embodiment of a compressible and expandable anode structure;

FIGS. 7A-7C depict an additional embodiment of a compressible and expandable anode structure; and

FIGS. 8A-8D depict yet another embodiment of a compressible and expandable anode structure.

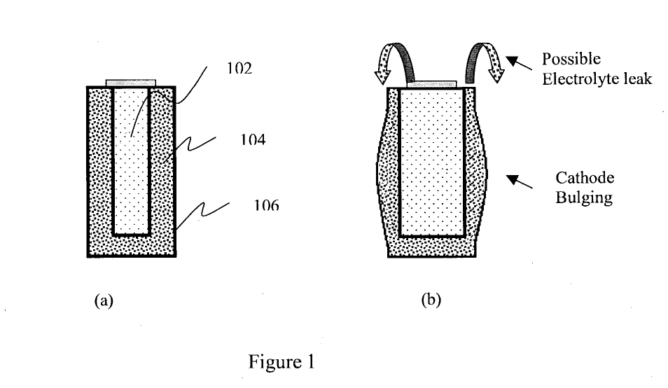

### DETAILED DESCRIPTION OF THE ILLUSTRATIVE EMBODIMENTS

Referring now to the drawings, illustrative embodiments of the present invention will be described. For clarity of the description, like features shown in the figures shall be indicated with like reference numerals and similar features as shown in alternative embodiments shall be indicated with similar reference numerals.

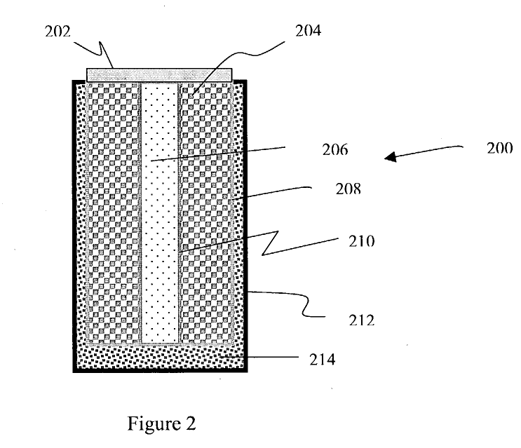

FIG. 2 shows a schematic representation of a metal air cell 200. The cell 200 includes a cap assembly 202. Anodes 204 are generally provided on opposing sides of an expansion compensation layer 206. Anode material 204 is generally covered with by a separator 208, generally to prevent dispersion or loss of zinc or zinc oxide from the anode structure. Ionic conduction is provided with electrolyte 214. These anode plates 208 are attached to a current collector 210. The components are within a housing 212.

Electrochemical cell 200 is a metal air or metal oxygen cell, wherein the metal is supplied from the metal anode structure 204 and the oxygen is supplied to an air diffusion electrode (not shown in FIG. 2). The anode 204 and the air diffusion electrode are maintained in electrical isolation from one another by the separator 208.

Oxygen from the air or another source is used as the reactant for the air diffusion electrode of the metal air cell 200. When oxygen reaches the reaction sites within the air diffusion electrode, it is converted into hydroxyl ions together with water. At the same time, electrons are released to flow as electricity in the external circuit. The hydroxyl travels through the separator 208 to reach the metal anode 204. When hydroxyl reaches the metal anode (in the case of an anode 204 comprising, for example, zinc), zinc hydroxide is formed on the surface of the zinc. Zinc hydroxide decomposes to zinc oxide and releases water back to the alkaline solution. The zinc oxide tends to increase the volume of the cell, and accordingly, compensating layer 206 serves to accommodate this space. The reaction is thus completed.

The anode reaction is:

Zn+4OH⁻→Zn(OH)₄ ²⁻+2e (1)

Zn(OH)₄²⁻→ZnO+H₂O+2OH⁻ (2)

The cathode reaction is:

½O₂+H₂O+2e→2OH⁻ (3)

Thus, the overall cell reaction is:

Zn+½O₂→ZnO (4)

The anode 204 generally comprises a metal constituent such as metal and/or metal oxides and a current collector 210. Optionally an ionic conducting medium is provided within the anode 204. Further, in certain embodiments, the anode 204 comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, and oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. The metal constituent may be provided in the form of powder, fibers, dust, granules, flakes, needles, pellets, or other particles.

The anode current collector 210 may be any electrically conductive material capable of providing electrical conductivity and optionally capable of providing support to the anode 112. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure. The anode 204 may be secured to the current collector, or the current collector may otherwise be integrally formed within the anode 204.

The ionic conducting medium generally comprises alkaline media to provide a path for hydroxyl to reach the metal and metal compounds. The electrolyte generally comprises ionic conducting materials such as KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

The optional binder of the anode 204 primarily maintains the constituents of the anode in a solid or substantially solid form in certain configurations. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The oxygen supplied to air diffusion electrode may be from any oxygen source, such as air; scrubbed air; pure or substantially oxygen, such as from a utility or system supply or from on site oxygen manufacture; any other processed air; or any combination comprising at least one of the foregoing oxygen sources.

Any conventional air diffusion cathode may be used, for example generally comprising an active constituent and a carbon substrate, along with suitable connecting structures, such as a current collector. Typically, the air diffusion electrode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable air diffusion electrode catalysts and formulations. The air diffusion electrode may also be a bi-functional, for example, which is capable of both operating during discharging and recharging.

An exemplary air cathode is disclosed commonly assigned U.S. Pat. No. 6,368,751, entitled “Electrochemical Electrode For Fuel Cell”, to Wayne Yao and Tsepin Tsai, filed on Oct. 8, 1999, which is incorporated herein by reference in its entirety. Other air cathodes may instead be used, however, depending on the performance capabilities thereof, as will be obvious to those of skill in the art.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode 114. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the air diffusion electrode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode 114. The catalyst material is generally provided in an effective amount to facilitate oxygen reaction at the cathode 114. Suitable catalyst materials include, but are not limited to: manganese, lanthanum, strontium, cobalt, platinum, and combinations and oxides comprising at least one of the foregoing catalyst materials.

To electrically isolate the anode 204 from the air diffusion electrode, the separator 208 is provided between the electrodes. In certain embodiments of the cell 200 herein, the separator 208 is disposed in ionic contact with the anode 204 to form an electrode assembly. In other embodiments, the separator 208 is disposed in physical and ionic contact with at least a portion of at least one major surface of the anode 204 to form an electrode assembly. In still further embodiments, the separator 208 is disposed in physical and ionic contact with substantially all of one major surfaces of the anode 204 to form an electrode assembly. In still further embodiments, the separator 208 is disposed in physical and ionic contact with substantially all of two major surfaces of the anode 204 to form an electrode assembly.

The physical and ionic contact between the separator and the anode may be accomplished by: direct application of the separator 208 on one or more major surfaces of the anode 204; enveloping the anode 204 with the separator 208; use of a frame or other structure for structural support of the anode 204, wherein the separator 208 is attached to the anode 204 within the frame or other structure; or the separator 208 may be attached to a frame or other structure, wherein the anode 112 is disposed within the frame or other structure.

Separator 208 may be any commercially available separator capable of electrically isolating the anode 204 and the air diffusion electrode, while allowing sufficient ionic transport between the anode 204 and the air diffusion electrode. Preferably, the separator 208 is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator 208 may also comprise additives and/or coatings such as acrylic compounds and the like to make them more wettable and permeable to the electrolyte.

In certain embodiments, the separators 208 comprise ionically conductive membranes suitable as a separator are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. Pat. No. 6,358,651 entitled “Solid Gel Membrane Separator in Rechargeable Electrochemical Cells”, by Muguo Chen, Tsepin Tsai and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

In certain embodiments, the polymeric material used as separator comprises a polymerization product of one or more monomers selected from the group of water soluble ethylenically unsaturated amides and acids, and optionally a water soluble or water swellable polymer. The polymerized product may be formed on a support material or substrate. The support material or substrate may be, but not limited to, a woven or nonwoven fabric, such as a polyolefin, polyvinyl alcohol, cellulose, or a polyamide, such as nylon.

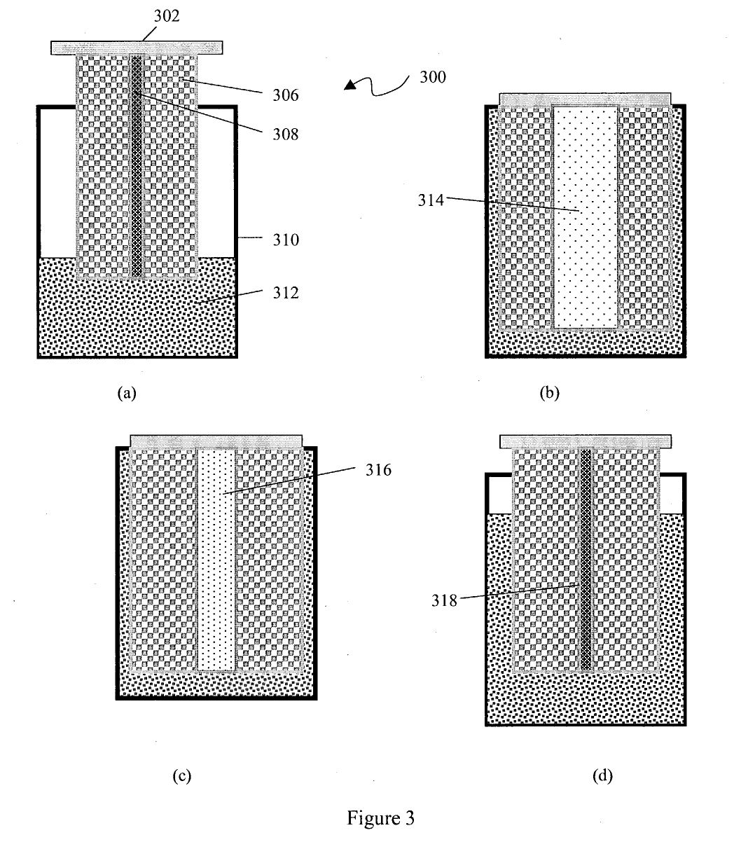

Referring now to FIGS. 3A-3D, refueling steps and benefits of the present invention are shown. An electrochemical cell 300 includes anode 306, air diffusion electrodes 310 and electrolyte 312 in between when activated. Referring to FIG. 3A, compensating layer 308 is maintained in a compressed state for easy insertion. The anode structure generally includes, therefore, a pair of anode portions 306 with the compensating layer 308 therebetween, and a cap portion 302. The cap portion 302 may optionally include at least a portion of a mechanism used to collapse and/or expand the compensating layer 308.

When the anode is completely inserted in the cell, and referring now to FIG. 3B, the compensating layer 314 expands towards the air diffusion electrodes, thus reducing the gap between cathode and anode. As there is only thin layer of electrolyte remains present between cathode and anode, the electrolyte resistance may decrease thus decreasing overall cell internal resistance.

Referring now to FIG. 3C, during discharging operations, the expansion of the anode is accommodated by the compensating layer 316. This prevents any excessive pressure on cathode, structural damage, and other detriments described above.

Referring now to FIG. 3D, during refueling operations, the compensating layer may be induced into a compressed state for easier anode removal process. Thus, the anode structure may be removed while minimizing or eliminating the likelihood of damage to the air diffusion electrode structures.

The compensating layer may be formed with: mechanical structures; electromechanical structures; air bags or balloons; shape memory allow materials; materials having elastic properties in combination with any of the foregoing.

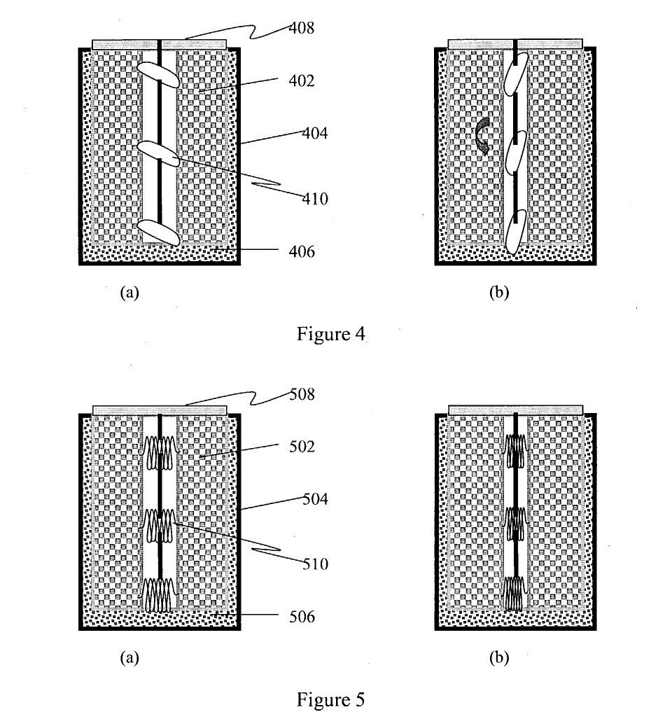

FIG. 4 shows example of mechanical structure suitable for inducing compression and/or expansion of an anode structure. An electrochemical cell comprises an anode 402 and a cathode 404 with electrolyte 406 in ionic contact with the anode and cathode. An anode structure includes an anode cap 408, and a mechanically rotatable structure 410. The anode cap 408 and mechanically rotatable structure 410 are linked to each other and optionally to an external ganging device to join several cells, with suitable mechanical structures or devices, including but not limited to, gears, cams, rollers, springs, etc. Alternatively, electromechanical devices may be used, such as any one or more of pressure sensors, actuators, motors, etc. The mechanically rotatable structure 410 can be formed of any suitable material that preferably is inert to caustic electrolyte (e.g., KOH).

Referring now to FIG. 5, another embodiment similar to FIG. 4 is shown, incorporating springs 510 as the compensating layer.

Mechanical displacement of the anode sections (e.g., the function of the compensating layer) may alternatively be effected by shape memory alloy devices. These materials, which may be in the form of wires, tubes, or plates, demonstrate the ability to return to a previously defined shape and/or size when subjected to an appropriate thermal procedure. These materials may include, for example, nickel-titanium alloys and copper-based alloys such as copper-zinc-aluminum and copper-aluminum-nickel.

Shape memory alloy materials are known, and have been in use for decades. Shape memory alloys are alloys which undergo a crystalline phase transition upon applied temperature and/or stress variations. In normal conditions, the transition from a shape memory alloy's high temperature state, austenite, to its low temperature state, martensite, occurs over a temperature range which varies with the composition of the alloy, itself, and the type of thermal-mechanical processing by which it was manufactured.

When stress is applied to a shape memory alloy member while in the austenite phase, and the member is cooled through the austenite to martensite transition temperature range, the austenite phase transforms to the martensite phase, and the shape of the shape memory alloy member is altered due to the applied stress. Upon the application of heat, the shape memory alloy member returns to its original shape when it transitions from the martensite phase to the austenite phase.

In general, shape memory alloys can be categorized into two classes: one-way and two-way. Upon heating to a specific temperature range, one-way shape memory alloys recover a predefined shape, which is predefined with suitable heating steps. One-way shape memory alloys do not returned to the original shape upon cooling. Two-way shape memory alloys, on the other hand, return to the preheated shape after cooling. Further detail regarding shape memory alloys is known, for example, is described in “Shape Memory Alloys” by Darel E. Hodgeskin, Ming H. Wu, and Robert J. Biermann¹. ¹http://www.sma-inc.com/SMA.Paper.html

Accordingly, the material of the shape memory alloy hinge should be selected so that unwanted shape memory alloy change does not take place. The internal temperature of the cell should not rise to level that will cause the shape memory alloy to undergo change. Alternatively, this internal temperature can be used as a mechanism to purposely induce shape change of the shape memory alloy. This may be useful, for example, as a safety device to prevent overheating of the cell.

Generally, to provide controlled compression or expansion of the anode, a heating system is employed (not shown). A heating system may include one or more electric heaters proximate to the shape memory alloy. Alternatively, electric current may be passed through the shape memory alloy to heat it to the desired temperature.

Note that to prevent electrical shorting, one or both ends of the shape memory alloy hinge should be secured to an insulator upon the appropriate electrode.

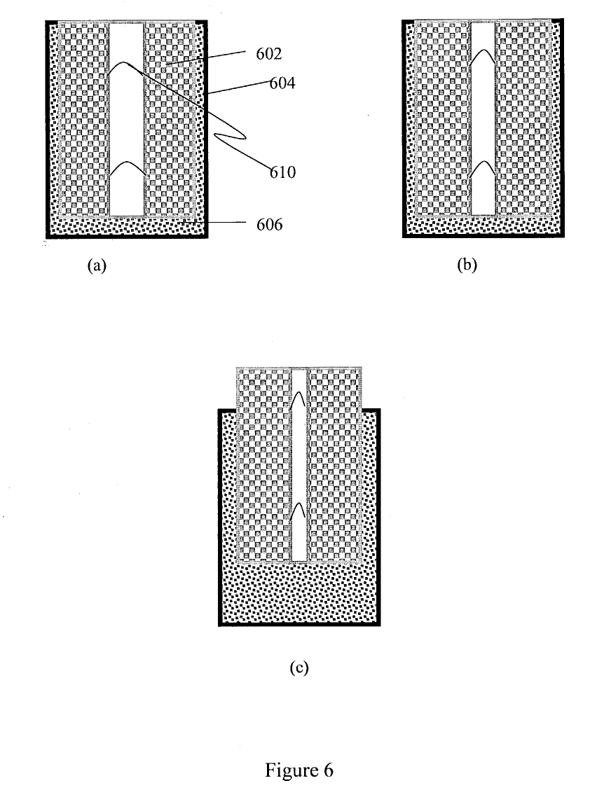

Referring generally to FIGS. 6A-6C, an example of mechanical structure suitable for inducing compression and/or expansion of an anode structure is provided. An electrochemical cell comprises an anode 602 and a cathode 604 with electrolyte 606 in ionic contact with the anode and cathode. An anode structure includes shape memory alloy hinges 610. As shown in FIG. 6A, the shape memory alloy hinges 610 are in their original configuration. Upon expansion of the anode material during discharge, and referring now to FIG. 6B, the shape memory alloy hinges 610 act as springs, and compensate for the anode expansion. Finally, when it is desired to remove the anode, and referring now to FIG. 6C, the alloy hinge 610 is heated to change to its preset heated state shape.

With a one-way shape memory alloy hinge, when the alloy is heated to change shape (i.e., as shown generally from FIG. 6B to the position in FIG. 6C), the shape memory alloy generally will not return back to the original configuration (i.e., the configuration of FIG. 6B, and the configuration of the shape memory alloy wherein upon heating it expands to the configuration in FIG. 6C). Therefore, an external force must be provided to return the electrodes into ionic contact, which would accordingly return the shape memory alloy hinge to the position before heating. This force may be provided manually, with springs, with other shape memory alloy actuators, or with a variety of other mechanical apparatus. Further, this may be an automated system, whereby an electronic controller determines the need to revert to the original position and subsequently provides a signal for the mechanical force.

With the two-way shape memory alloy hinge, the heat that is utilized to transform the shape of the hinge must be maintained in order to maintain the shape. When the heat is removed, the shape memory alloy hinge 610 reverts back to the shape of the unheated hinge.

Note that with either the one-way or two-way shape memory alloys, the preheated and heated shapes may be associated with different positions of the configurations shown in FIGS. 6A-6C. For instance, and in one configuration, the preheated shape of the shape memory alloy hinge 610 may be as depicted in FIG. 6A, and the heated shape depicted in FIG. 6C. Alternatively, the preheated shape may be as depicted in FIG. 6C, and the heated shape may be as depicted in FIG. 6A or 6B. In this embodiment, for instance with a two-way shape memory alloy, the power to provide the heat to the shape memory alloy hinge to maintain in the position of ionic contact may be derived from the cell itself.

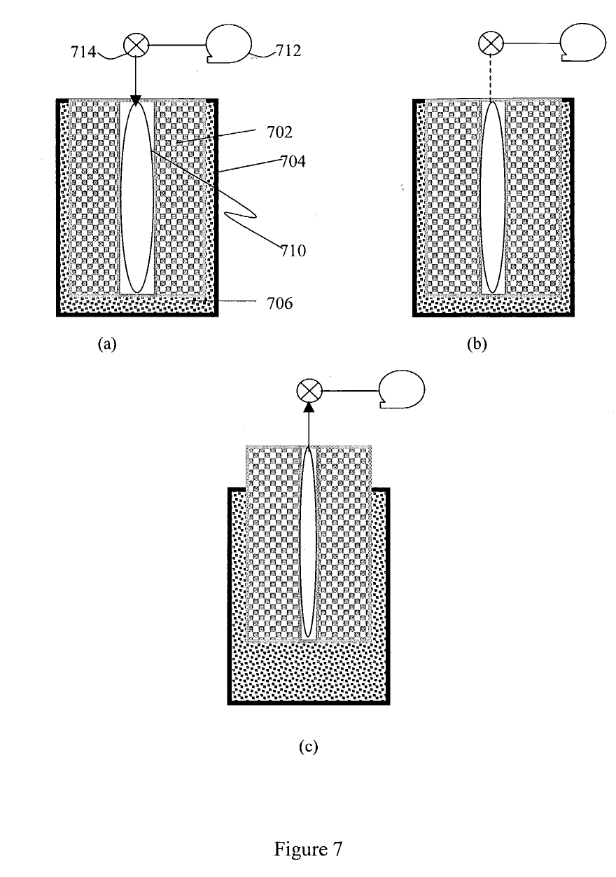

Referring now to FIGS. 7A-7C, an example of a balloon structure suitable for inducing compression and/or expansion of an anode structure is provided. An electrochemical cell comprises an anode 702 and a cathode 704 with electrolyte 706 in ionic contact with the anode and cathode. An anode structure includes a balloon structure 710 operable connected to a reversible pump 712 via, e.g., a suitable valve control structure 714. Note that the reversible pump 712 may comprise a system of pumps and suitable plumbing. The balloon structure 710 may be filled with any suitable fluid (gas or liquid). As shown in FIG. 7A, the balloon structure 710 is in an expanded condition to allow for close physical proximity between the anodes and cathodes. Upon expansion of the anode material during discharge, and referring now to FIG. 7B, the balloon structure 710 releases fluid, and compensate for the anode expansion. Finally, when it is desired to remove the anode, and referring now to FIG. 7C, the balloon structure 710 evacuated to close the space between the anode portions.

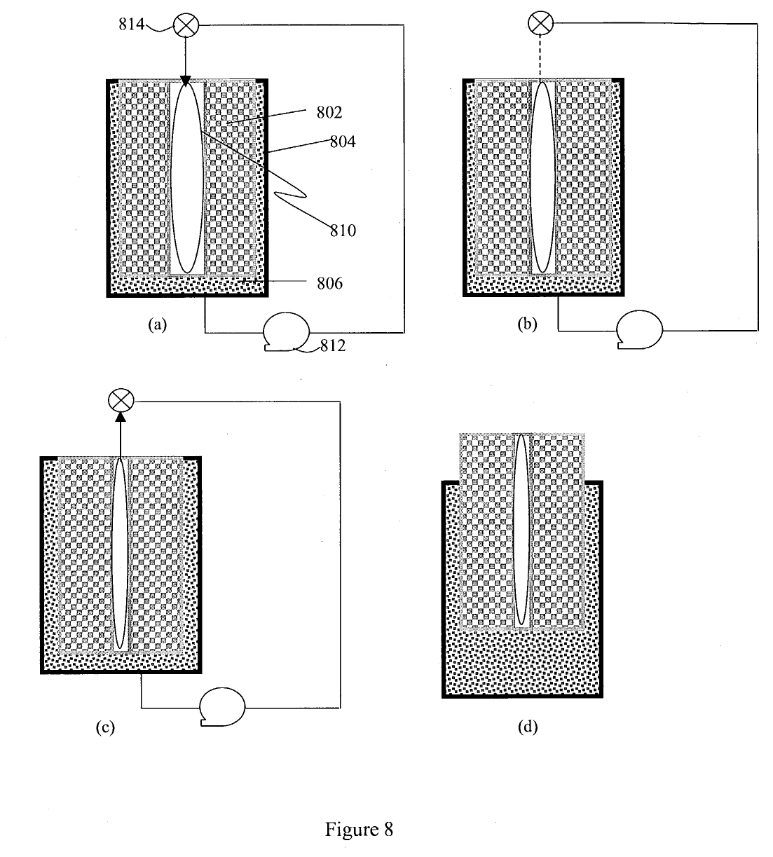

Referring now to FIGS. 8A-8D, an example of a balloon structure suitable for inducing compression and/or expansion of an anode structure is provided. In this embodiment, a reversible pump 812 pumps electrolyte into and out of the balloon structure 810. Note that the reversible pump 812 may comprise a system of pumps and suitable plumbing. This serves to provide the features of the present invention (i.e., maintaining suitable distance between opposing electrodes, compensate for anode expansion, and/or facilitate removal of the anode), as well as provide a system for electrolyte management. Note that the pump 812 may be connected to electrolyte within the cell housing, an external reservoir (not shown), or both.

Incorporation of the compensating layer (i.e., a compressible and/or expandable anode structure) provides the following advantages:

Prevention of structural damage from anode expansion.

Reduces cell internal resistance by minimizing the electrolyte gap.

Prevention of forced leakage of electrolyte therefore extends serviceable lifetime and performance due to elimination or minimization of no corrosion.

Ease of refueling

Useful for interrupted discharging applications.

Compensating layer can be used as a reserve for storing excessive electrolyte.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An anode structure comprising metal fuel, a current collector in electric contact with metal fuel, and a compressible member in mechanical cooperation with the current collector or the metal fuel.

2. The anode structure as in claim 1 whereupon electrochemical reaction of the metal fuel, any expansion of the metal fuel is transferred to the compressible member.

3. An anode structure comprising a pair of metal fuel portions each in electrical conduction with a current collector and a compressible member between the metal fuel portions.

4. An electrochemical cell comprising the anode structure as in claim 1, a cathode in electrical isolation from the metal fuel wherein the compressible member mechanically acts on the metal fuel to decrease distance between the metal fuel and the cathode.

5. The electrochemical cell as in claim 4, further comprising electrolyte for ionic connection between metal fuel and the cathode.

6. An electrochemical cell comprising the anode structure as in claim 1, a cathode in electrical isolation from the metal fuel, wherein the cathode is within a housing configured for receiving the anode structure, and wherein removal of the anode structure is facilitated by compression of the compressible member to decrease distance between the metal fuel and the cathode.

7. An anode structure as in claim 1 where the compressible member comprises mechanical structures, electromechanical structures, air bags or balloons, shape memory alloy, or any material with elastic properties.

8. An electrochemical cell comprising the anode structure as in claim 2, a pair of cathode portions in ionic communication with each metal fuel portion, wherein the compressible member mechanically acts on the metal fuel portions to decrease distance between the metal fuel portions and the cathode portions.

9. The electrochemical cell as in claim 8, further comprising electrolyte for ionic connection between metal fuel and the cathode.

10. An electrochemical cell comprising the anode structure as in claim 2, a pair of cathode portions in ionic communication with each metal fuel portion, wherein the cathode portions are within a housing configured for receiving the anode structure, and wherein removal of the anode structure is facilitated by compression of the compressible member to decrease distance between the metal fuel portions and the cathode portions.

11. An anode structure as in claim 2 where the compressible member comprises mechanical structures, electromechanical structures, air bags or balloons, shape memory alloy, or any material with elastic properties.
